(19) United States
(12) Patent Application Publication
(10) Pub. No.: US 2018/0219432 A1
(43) Pub. Date: Aug. 2, 2018

(54) SYSTEM AND METHODS FOR USING A WIRELESS POWER MODEM FOR CONTROL OF WIRELESS POWER TRANSFER

(71) Applicant: POWERMAT TECHNOLOGIES LTD., NEVE ILAN (IL)

(72) Inventors: IAN PODKAMIEN, PETACH TIKVA (IL); AMI OZ, AZOR (IL); NADAV REUVENI, MEVASSERET ZION (IL); YUVAL KOREN, REHOVOT (IL); EDUARDO ALPERIN, RAANANA (IL)

(21) Appl. No.: 15/748,417

(22) PCT Filed: Jul. 28, 2016
(86) PCT No.: PCT/IL2016/050833

§ 371 Date: Jan. 29, 2018

Related U.S. Application Data
(60) Provisional application No. 62/198,135, filed on Jul. 29, 2015.
(60) Provisional application No. 62/249,961, filed on Nov. 3, 2015.

(51) Int. Cl. H02J 50/80; H02J 50/10; H02J 50/40; H02J 7/02; H04B 5/00

(52) U.S. Cl. CPC H02J 50/80; H02J 50/10; H04B 5/0075; H02J 7/025; H04B 5/0037; H02J 50/40

(57) ABSTRACT

The disclosure relates to system and methods for managing a network of power outlet devices configured to transmit power wirelessly for charging electrical devices. In particular the invention relates to a plurality of wireless power outlets controlled centrally via a wireless power modem and operable to power electrical devices using various associated power transfer protocols. Each power transfer servicing venue may be equipped with wireless power outlets supporting a protocol or technology—resonant, non-resonant, magnetic beam, inductive power transfer and the like. The current disclosure introduces a wireless power modem accessible externally via a network communication API and operable to control a plurality of wireless power outlets, each using an associated power transfer protocol via a power-transfer software application kit (SDK).

### FIELD OF THE INVENTION

The disclosure herein relates to system and methods for managing a network of devices configured to transmit power wirelessly for charging electrical devices. In particular the invention relates to a plurality of wireless power outlets controlled centrally via a wireless power modem and operable to power electrical devices using various associated power transfer protocols.

### BACKGROUND OF THE INVENTION

The spread of mobile devices such as mobile handsets, media players, tablet computers and laptops/notebooks/netbooks and ultra-books increases user demand for access to power points at which they may transfer power to charge mobile devices while out and about or on the move.

Wireless power transfer via inductive coupling allows energy to be transferred from a power supply to an electric load without a wired connection therebetween. An oscillating electric potential is applied across a primary inductor. This sets up an oscillating magnetic field in the vicinity of the primary inductor. The oscillating magnetic field may induce a secondary oscillating electrical potential in a secondary inductor placed close to the primary inductor. In this way, electrical energy may be transmitted from the primary inductor to the secondary inductor by electromagnetic induction without a conductive connection between the inductors.

When electrical energy is transferred from a primary inductor to a secondary inductor, the inductors are said to be inductively coupled. An electric load wired in series with such a secondary inductor may draw energy from the power source wired to the primary inductor when the secondary inductor is inductively coupled thereto.

There is a need for systems that conveniently provide the opportunity to transfer power for charging the electrical devices in public spaces, in which the user of the mobile device may remain for extended periods of time, say more than a few minutes or so. Amongst others, such public spaces may include restaurants, coffee shops, airport lounges, trains, buses, taxis, sports stadia, auditoria, theatres, cinemas or the like.

Such systems may be distributed over various venues, requiring complex network architecture to provide the demand for wireless power transfer in public spaces. Each power transfer servicing venue may be equipped with wireless power outlets supporting a protocol or technology—resonant, non-resonant, magnetic beam, inductive power transfer and the like. The diversification of technologies may prevent providing the required service of power transfer to electrical devices which do not support or are not compatible with the technology of the wireless power outlet, making the control and management of such power transfer networks a complex and expensive task.

The invention described hereinafter addresses the above-described needs providing the mechanism to control a plurality of wireless power outlets, each of being operable to power electrical devices using various power transfer protocols.

### SUMMARY OF THE INVENTION

According to one aspect of the presently disclosed subject matter, there is provided a system for controlling a wireless power transfer network, the system comprising: a plurality of wireless power outlets operable to transfer power to at least one electrical device associated with a wireless power receiver, each of the plurality of wireless power outlets is configured to power the at least one electrical device using an associated power transfer protocol; and at least one wireless power modem in communication with one or more of the plurality of wireless power outlets, the at least one wireless power modem operable to execute instructions directed to: receiving an identification code, the identification code comprising data pertaining to the power transfer protocol associated with a selected wireless power outlet; controlling wireless power transfer from the selected wireless power outlet, wherein the at least one wireless power modem comprises: a power-outlet communication manager configured to control one or more of the plurality of wireless power outlets; and a power-transfer software development kit (SDK) including a library of pre-determined power-protocol interfaces, and a power-protocol interface selector for selecting a power-protocol interface specific to the power transfer protocol associated with the selected wireless power outlet being operated.

Accordingly, the power-transfer SDK comprises a set of tools configured to provide a dedicated layer for each associated power transfer protocol to enable interfacing according to the power-protocol interface.

As appropriate, the at least one wireless power modem is accessible from a communication network via a network communication interface.

Optionally, the identification code is being received from the at least one wireless power outlet.

Optionally, the identification code is being received from the wireless power receiver.

Optionally, the identification code is being received from a centrally managed control server.

Variously, the associated power-transfer protocol is selected from a group consisting of: a non-resonance power transfer technology, a resonance power transfer technology, a magnetic multiple-input multiple-output (MIMO) power transfer technology, an inductive power transfer technology and a conformable third party proprietary technology.

As appropriate, each of the plurality of wireless power outlets is connectable to the at least one wireless power modem via a wired connection.

Optionally, each of the plurality of wireless power outlets is connectable to the at least one wireless power modem wirelessly.

Variously, the network communication interface is selected from a group consisting of: a proprietary Application Programming Interface (API), a Zigbee interface, a WiFi interface and combinations thereof.

According to another aspect of the presently disclosed subject matter, there is provided a wireless power modem configured to control a plurality of wireless power outlets, each of the plurality of wireless power outlets being operable to power at least one electrical device using an associated power transfer protocol, wherein the wireless power modem is configured to selectively operate at least one of the plurality of wireless power outlets according to the associated power transfer protocol, and wherein the wireless power modem comprises: a power-outlet communication manager configured to control one or more of the plurality of wireless power outlets; and a power-transfer software application kit (SDK) including a library of pre-determined power-protocol interfaces, and a power-protocol interface selector for selecting a power-protocol interface specific to the power transfer protocol associated with the wireless power outlet being operated.

As appropriate, the wireless power modem is accessible from a communication network via a network communication interface.

Variously, the network communication interface is selected from a group consisting of: a proprietary Application Programming Interface (API), a Zigbee interface, a WiFi interface and combinations thereof.

As appropriate, the wireless power modem, further comprising a plurality of connectors for connecting to each of the plurality of wireless power outlets via a wired connection.

Optionally, the wireless power modem, further comprising a wireless communicator for connecting to each of the plurality of wireless power outlets wirelessly.

Variously, the associated power transfer protocol is selected from a group consisting of: a non-resonance power transfer technology, a resonance power transfer technology, a magnetic multiple-input multiple-output (MIMO) power transfer technology, an inductive power transfer technology and a conformable third party technology.

Still a method is disclosed for controlling a wireless power transfer system, the wireless power system comprising: at least one wireless power outlet configured to power at least one electrical device using an associated power transfer protocol; and at least one wireless power modem in communication with the at least one wireless power outlet; and at least one control server in communication with the at least one wireless power modem via a network communication interface, the method comprising:

receiving an identification code, the identification code comprising data pertaining to the power transfer protocol associated with a selected wireless power outlet; selecting a pre-determined power-protocol interface from a library of a power-transfer software application kit (SDK), the power-protocol interface specific to the power transfer protocol associated with the selected wireless power outlet; and controlling wireless power transfer from the selected wireless power outlet.

The method wherein the step of controlling wireless power transfer comprises: receiving at least one power command comprising data pertaining to controlling the at least one wireless power outlet; and executing an associated power command of an interface layer of the selected pre-determined power-protocol interface.

Variously, wherein the network communication interface is selected from a group consisting of: a proprietary Application Programming Interface (API), a Zigbee interface, a WiFi interface and combinations thereof.

Still another method is disclosed for controlling a wireless power transfer system, the method comprising: obtaining at least one wireless power modem configured to control a plurality of wireless power outlets; and connecting at least one wireless power outlet to the wireless power modem, the wireless power modem configured to power at least one electrical device using an associated power transfer protocol; receiving an identification code, the identification code comprises data pertaining to the power transfer protocol associated with a selected wireless power outlet; selecting a pre-determined power-protocol interface from a library of a power-transfer software application kit (SDK), the power-protocol interface specific to the power transfer protocol associated with the selected wireless power outlet; and controlling wireless power transfer from the selected wireless power outlet according to said associated communication protocol.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1A is a block diagram illustrating the main elements of an inductive power transfer system with a feedback signal path according to embodiments of the present invention;

FIG. 1B is a block diagram illustrating the main elements of an inductive power transfer system with an inductive feedback channel according to still another embodiment of the present power transfer system invention;

FIG. 2 is a system diagram schematically illustrating selected components of a network architecture with the various application interfaces;

FIGS. 3A-B are block diagrams schematically illustrating possible configurations of a wireless power transfer unit for use with the current system;

FIG. 3C is a block diagram schematically illustrating a possible configuration of a wireless power transfer unit according to the present invention;

FIG. 3D is a block diagram schematically illustrating a possible configuration of a wireless power modem managing a plurality of wireless power outlets via a communication module according to the present invention;

FIG. 3E is a block diagram schematically illustrating a possible structural layout of a wireless power mode connectable to a plurality of outlets, according to the present invention;

FIGS. 4A-E is a system distribution diagram schematically illustrating selected components of a distribution venue network for providing power wirelessly to electrical devices via wireless power outlets supporting various power transfer protocols;

FIG. 5 is a system diagram schematically illustrating a possible SDK layered structure for a wireless power modem controlling power outlets associated with various power transfer protocols;

FIGS. 6A-B are flowcharts illustrating selected actions of possible methods for managing and controlling wireless power transfer to electrical devices via a wireless power modem, remotely; and

FIGS. 7A-L are block diagrams of communication messages of the API used in a system managing a plurality of wireless power outlets.

### DETAILED DESCRIPTION

It is noted that the systems and methods of the invention herein, may not be limited in their application to the details of construction and the arrangement of the components or methods set forth in the following description or illustrated in the drawings and examples. The systems and methods of the invention may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

Accordingly, various embodiments may omit, substitute, or add various procedures or components as appropriate. For instance, it should be appreciated that the methods may be performed in an order different than described, and that various steps may be added, omitted or combined. Also, aspects and components described with respect to certain embodiments may be combined in various other embodiments. It should also be appreciated that the systems, methods, devices, and software may individually or collectively be components of a larger system, wherein other procedures may take precedence over or otherwise modify their application.

Aspects of the present invention relate to providing system and methods for managing a network of wireless power outlet devices configured to transmit power wirelessly for charging electrical devices. In particular, the present disclosure relates to controlling power provisioning via at least one wireless power modem configured to control various wireless power outlet using various power transfer protocols such as Power Matters Alliance (PMA), Alliance for Wireless Power (A4WP), Qi of Wireless Power Consortium (WPC), Beam Forming protocol (multiple input, multiple output=MIMO) or other third party associated power transfer technology.

As used herein, magnetic beam technology is associated with wireless power transfer using multi coil array to form the “Magnetic Beam” (“Phase Array” or MIMO, magnetic multiple-input multiple-output) and direct it towards the power receiver which may change position during power transmission. The Magnetic beam technology aims at increase of wireless power range.

Wireless power transfer systems technologies may use various configurations of coils and magnetic transfer techniques, such as inductive power transfer technology (non-resonant), magnetic resonance power technology, magnetic beam technology and the like. Thus, not every wireless power transmitter associated with a wireless power outlet is technically operable of transferring wireless power to a wireless power receiver associated with an electrical device.

As used herein, the wireless power outlet point refers to , variously, a TAP″ (Power Access Point), a ‘hotspot”, a ‘charger”, or a ‘charger spot”.

As used herein, the term “management server” refers to a server configured to manage multiple wireless power outlets configured to provide power transfer to electrical mobile devices, and controlling the power charging between an electrical mobile device and an associated wireless power outlet. The term “management server” refers to , variously, as a ‘control server”, “central server” or a ‘server”.

As used herein, the mobile electrical device refers to, variously, a ‘user device”, an “electrical device”, an “electronic device”, a ‘mobile device”, a ‘communication device” or a ‘device”. The device may be an electrical device with a battery, e.g., a mobile handset, a media player, a tablet computer, a laptop/notebook/netbook/ultra-book, a PDA or the like. Alternatively, the device may be an accessory with a battery, such as earphones and the like, or a stand-alone battery. As a further alternatively, the device may be any powered device, including electrical devices without a battery.

As used herein, inductive power transfer technology is associated with power transferred possibly over short distances by magnetic fields using inductive coupling between a primary coil and a secondary coil. Inductive power transfer may use resonant or non-resonant driving frequencies. Other equivalent power transfer technologies include other wireless power transfer technologies such as magnetic beam transfer, electric field technologies using capacitive coupling between electrodes.

As used herein, magnetic resonance power technology (also known as a resonant transformer, resonant-inductive coupling, or resonance charging) is associated with power transfer between two inductors that are tuned to resonate at the same natural resonant frequency. Resonance power technology may allow power to be transferred wirelessly over a distance with flexibility in relative orientation and positioning. Based on the principles of electromagnetic coupling, resonance-based chargers generate an oscillating current into a highly resonant coil to create an oscillating electromagnetic field. A second coil with the same resonant frequency receives power from the electromagnetic field and converts it back into electrical current that can be used to power and charge a portable device. Resonance charging may provide spatial freedom, enabling the transmitter (resonance charger) to be separated from the receiver (portable device) by several inches or more.

It is noted that currently, PMA's standard relies on magnetic induction, which requires devices to be placed on a charging surface for power transfer to happen. On the other hand, A4WP's charging standard relies on resonance charging, which may transmit power at greater distances, meaning devices can be a foot or two or even more away from a power transmitter and still receive power.

It is particularly noted that managing and controlling the various wireless power outlets, each configured to operate under a different power transfer protocol, as described hereinabove, is only functional with a common power-transfer SDK providing a common interfacing layer, as introduced by the current disclosure.

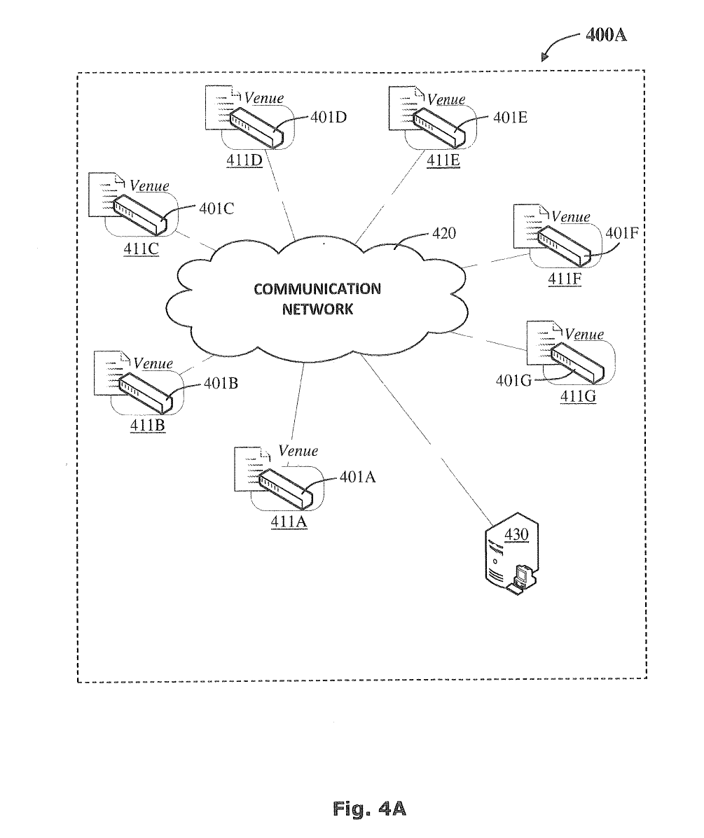

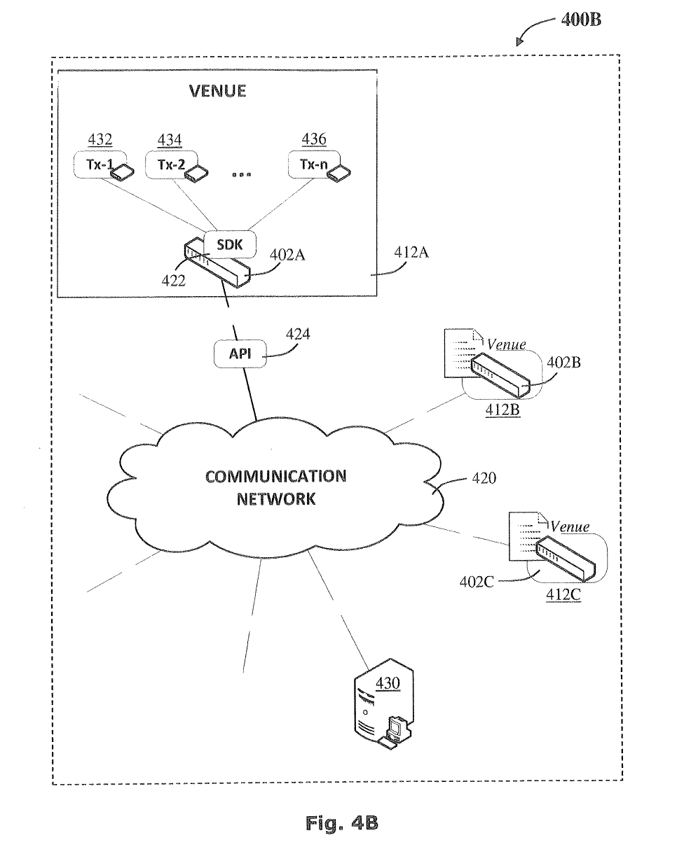

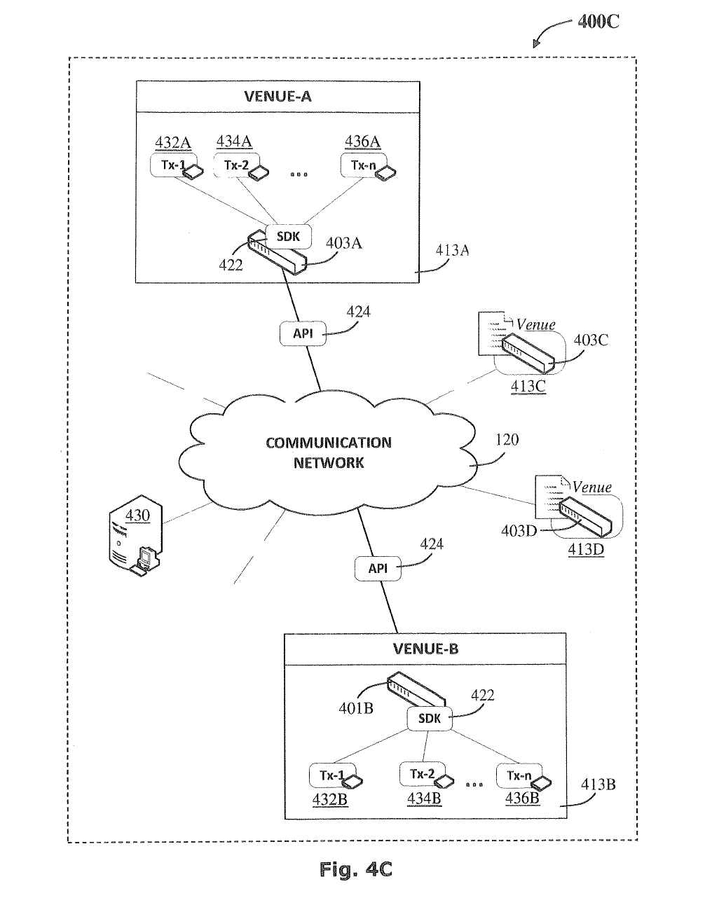

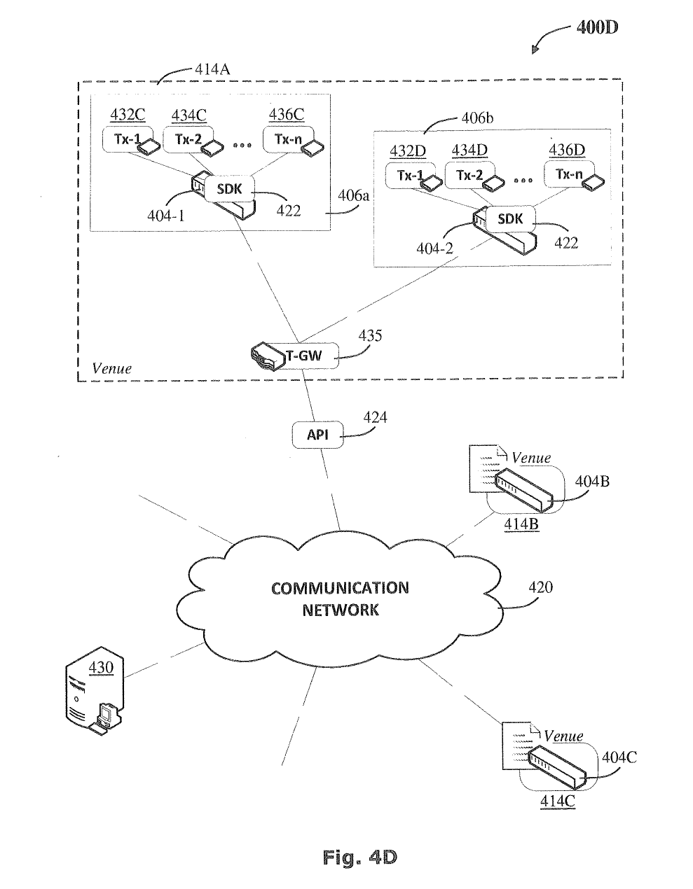

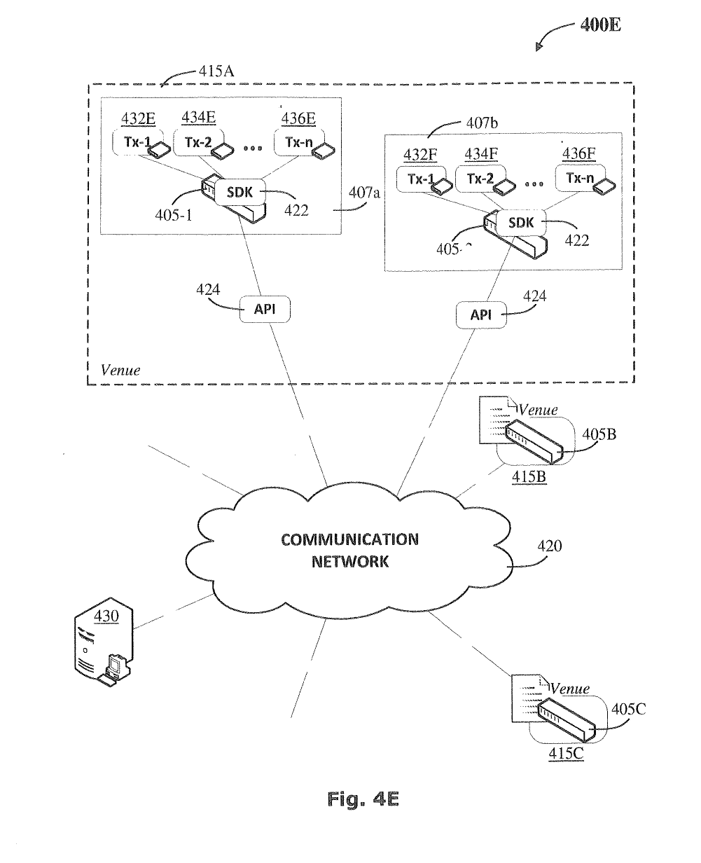

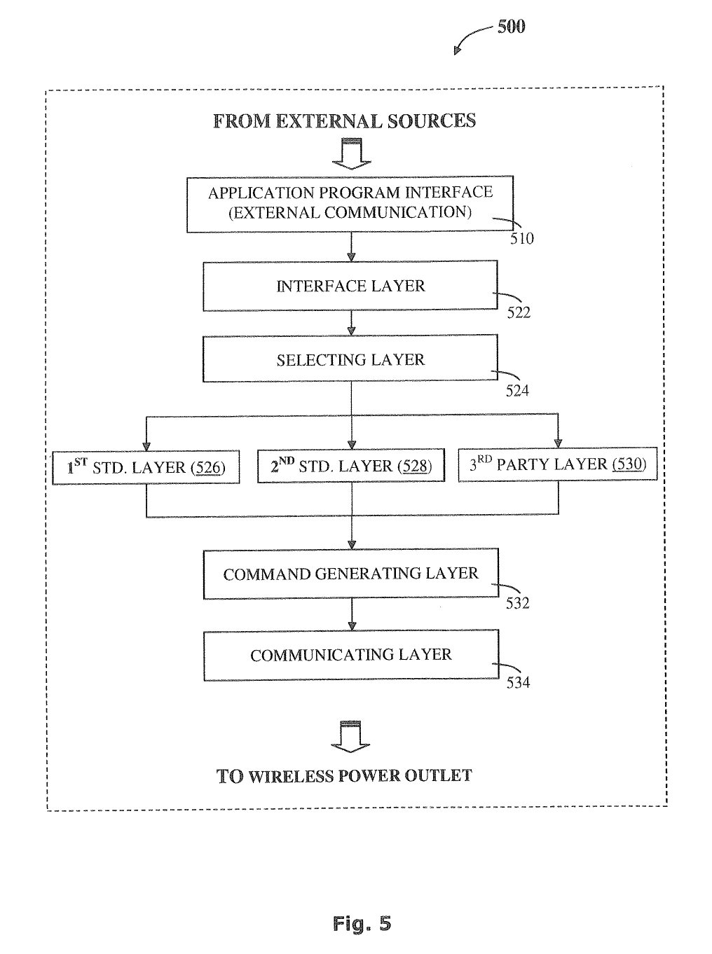

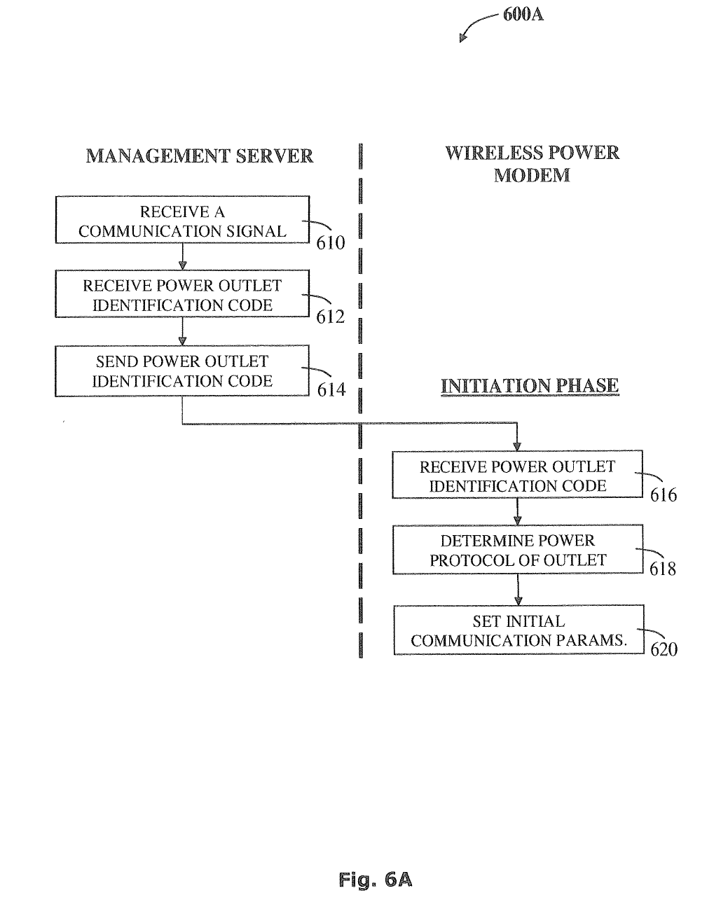

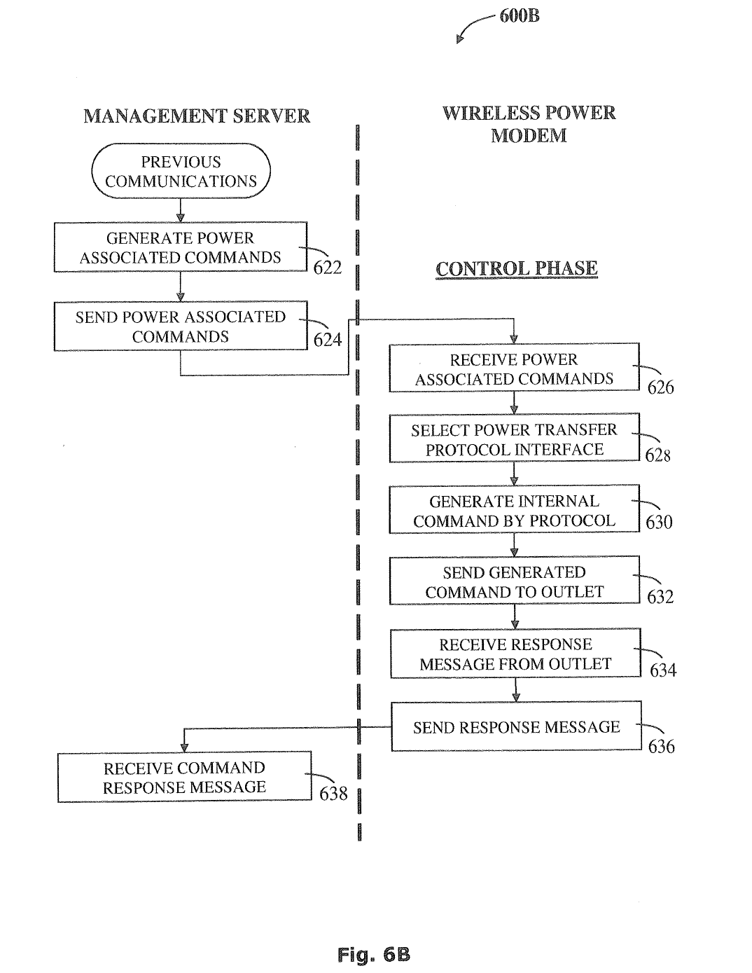

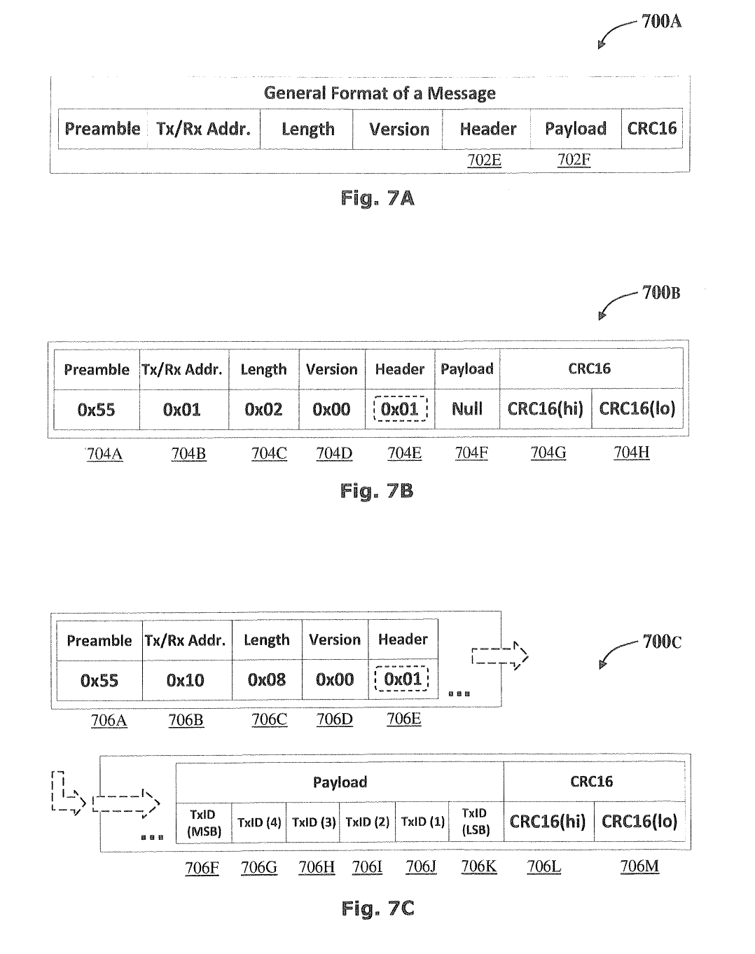

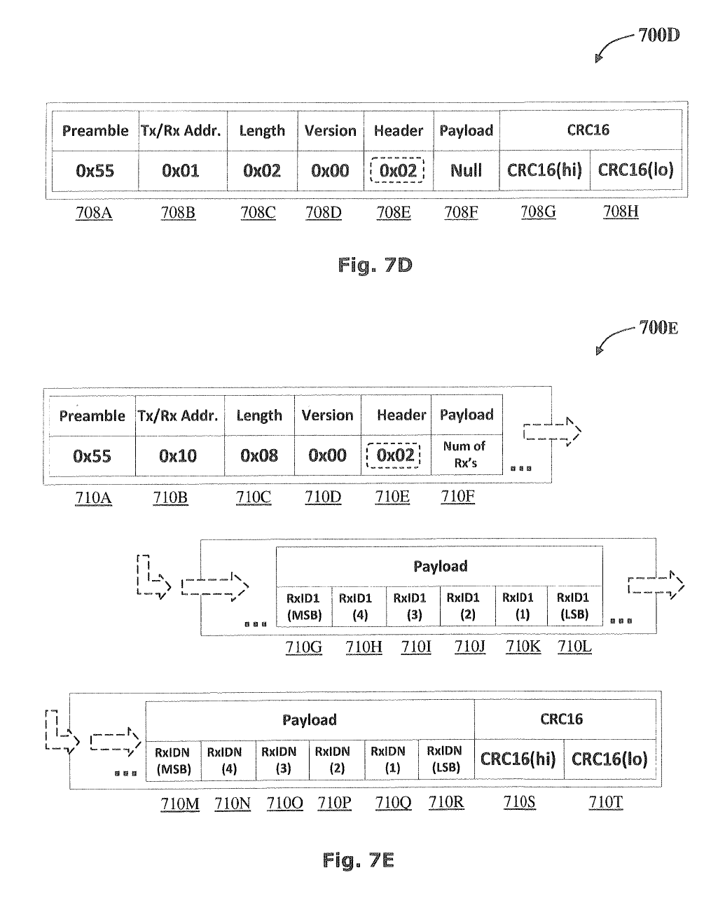

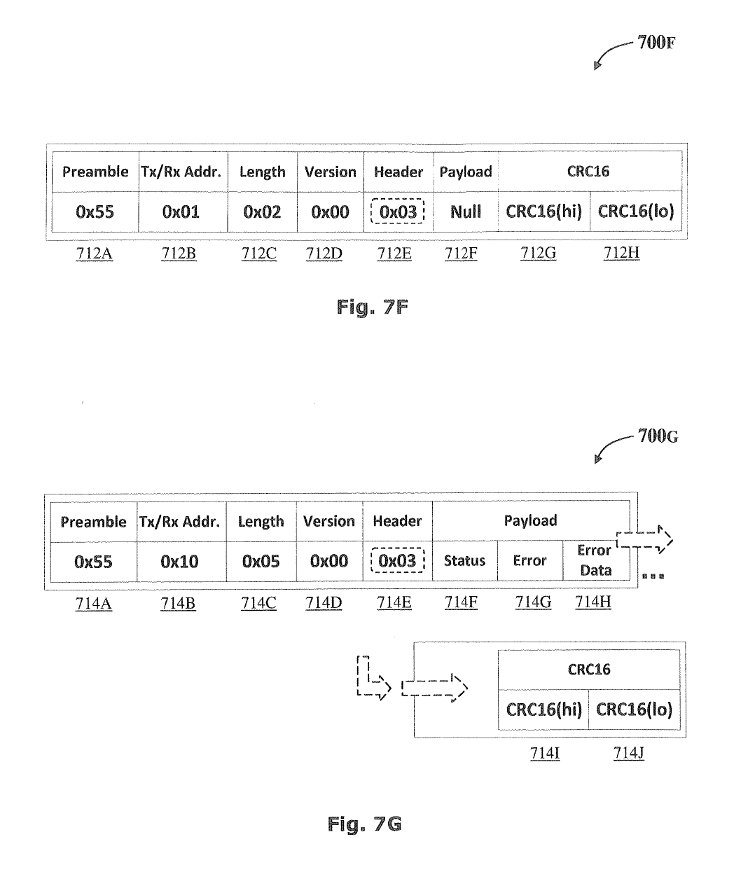

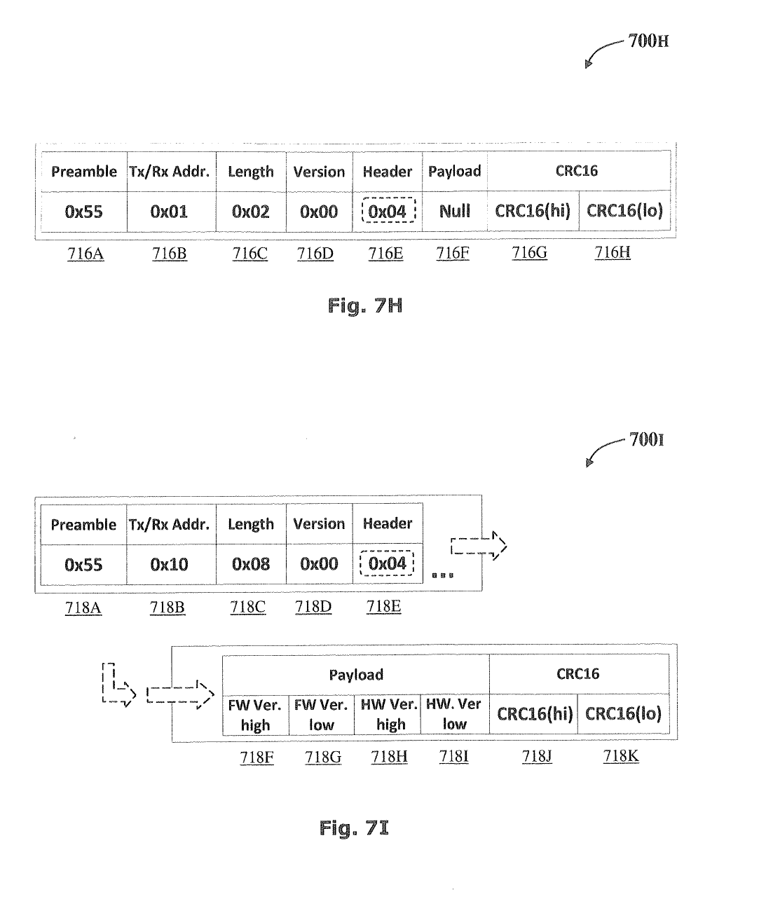

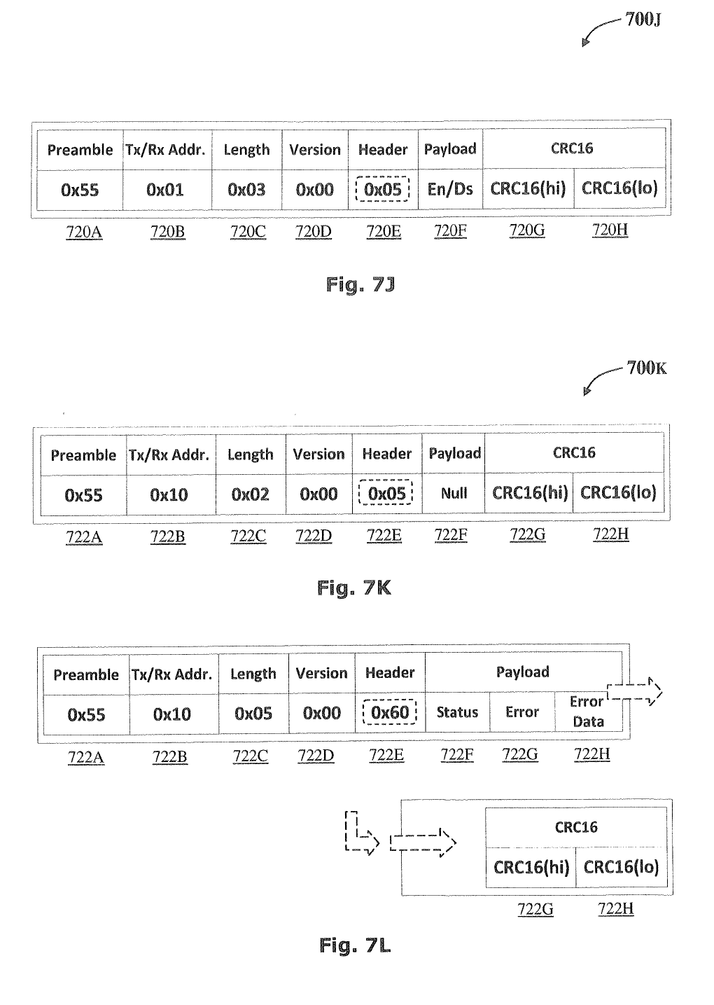

The technical solution details are described hereinafter in the system FIGS. 4A-E, the power-transfer SDK layered structured FIG. 5 and the flowcharts of FIG. 6A-B, illustrating the flow of interactions of a software application executed centrally and operable to control wireless power modem with appropriate power transfer protocol layers. FIGS. 7A-L provides a set of exemplified communication messages using a network API, in a non-limiting manner.

### Power Management:

The power management system of the current disclosure is a centrally managed system operable to execute on at least one control server in communication with at least one wireless power modem associated with a venue providing power charging services.

The centrally managed control server may further communicate with a management console locally or via a communication network.

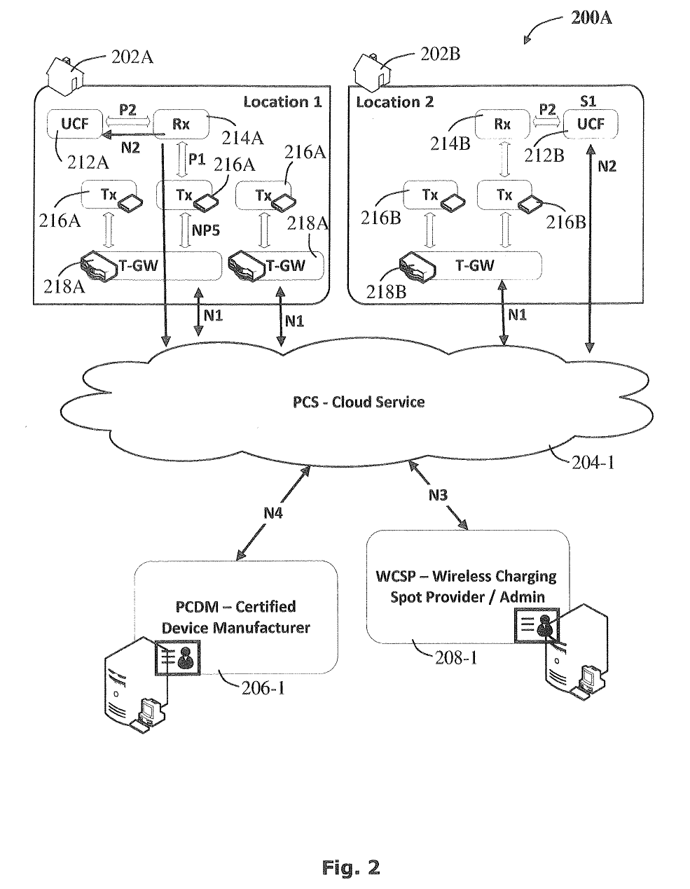

The centrally managed control server is operable to execute various power management software processes and applications, using various API's (of PMA power transfer protocol, as an example), as described in FIG. 2. The power management software may provide a platform, centrally covering power management aspects of a network of wireless power outlets distributed in public spaces and organizations. The power management software may provide a manager of a venue, for example, the ability to manage the wireless power outlets (hotspots, charging spots) that are installed therein, supporting various power transfer protocols such as PMA, A4WP, WPC, MIMO or other third party power transfer protocols. Optionally, the same management software system, with higher system administration rights, may allow power management of several venues or manage the whole organizational wireless power outlet network. The power management software is operable to provide remote control and monitoring, maintenance of wireless power outlets coupled with system remote health checking. The system is further operable to enable provisioning functionality, maintaining security and business goals using policy enforcement technique.

Various functionalities may be available through the power management software, and may also be available to third-party applications through network application programming interfaces (APIs) for the server or another client application. Without limiting the scope of the application, selected functionalities may include, amongst others:
Using satellite positioning, antenna triangulation, wireless network locations or in-door positioning location information to display a map with nearby public hotspots.
Booking a Hotspot in advance, and accordingly, the booked Hotspot will not charge for other users, only for the registered user when he arrives, and identified by the unique RxID.
Registering devices.
Checking power transfer statistics.
Buying accessories, charging policies.
Checking real-time power transfer balances for registered devices.
Setting notification methods, receiving notifications.
Setting an automatic check-in to the Hotspot location.
Setting automatic interactions with social networks, e.g. automatic check-ins, tweets, status updates, and the like.
Providing store-specific promotion updates via push notifications, for example, based on past and current usage of power transfer services and user's micro-location.
Using accumulated information of the usage of the wire transfer service, including locations and the like, to better target users with promotions/ads.
Creating loyalty plans for venues based on usage of the wire transfer services in their premises.
Providing services to users based on information that their social-network connections are/were at a close proximity.
Launching a third party application on a user's device based on past or current usage of power transfer services and user's micro-location.
Collecting statistical information associated with usage of the application

It is noted that if communication with the server cannot be established, the application may allow the providing of power transfer based on a predefined “offline policy”.

Optionally, the management software may provide monitoring of outlet network components, mapping of network elements, maintenance and event management, performance and usage data collector, management data browser and intelligent notifications allowing configurable alerts that will respond to specific outlet network scenarios.

Optionally, the power management software may enforce policies for command and control, these may include operational aspects such as power management aspects, defining who, when and where can charge and for how long, defining type of service (current) and the like.

Optionally, the power management software may include operational aspects of providing power transfer or control billing aspect associated with an electrical device. Thus, the power management software may be operable to provide features such as aborting power provision of a power transfer outlet, continue providing power, modifying the service or controlling one or more aspects of the power transfer procedure by enforcing a new policy, for example, or the like, possibly according to operating signals received. The power management software may further be operable to handle user accounts, registration of devices, user specific information, billing information, user credits and the like.

It is noted the management software may further be operable to detect undesirable conditions while coupling health checking functionality and remote maintenance. For example, events such as adding or removing a wireless power outlet in a venue, may be detected.

Optionally, the system may be configured that when a new wireless power outlet is detected, the system automatically responds in installing an appropriate policy.

Additionally or alternatively, the system may configured to transmit an alert the system administrator with an appropriate message.

Communicating with a Control Server:

A wireless power outlet is operable to transfer wireless power to an electrical mobile device associated with a power receiver and may be configured to respond to remote commands to enable system functionalities such as identification and authorization, power provisioning, maintenance, health checks and the like. Accordingly, the wireless power outlet needs to be in communication via a communication channel. Such a communication channel may be mediated by wireless access points, cellular networks, wired networks or the like that may provide an internet protocol (IP) connection to at least one of the wireless power outlet.

A centrally managed control server may be in communication with the wireless power outlet, directly, if the outlet includes a communication module. More commonly, the wireless power outlet may be managed and controlled via a venue gateway, where the gateway acts as an entrance node (or a stopping point) for the venue internal network. The gateway may further provide the logic of the software application, as communicated and defined by the controlling management server.

It is specifically noted that for the alternatives mentioned above, each requires a different software application according to the associated technology and power-transfer protocol of the wireless power outlet.

The wireless power modem of the current disclosure is operable to connect and control multiple wireless power outlets of various power transfer protocols, as described hereinafter in FIGS. 4A-E. The communication channel may be mediated by wireless access points, cellular networks, wired networks or the like that may provide an internet protocol (IP) connection to at least one of the wireless power modem.

### Description of the Embodiments:

It is noted that the systems and methods of the invention described herein may not be limited in their application to the details of construction and the arrangement of the components or methods set forth in the description or illustrated in the drawings and examples. The systems, methods of the invention may be capable of other embodiments or of being practiced or carried out in various ways.

Alternative methods and materials similar or equivalent to those described herein may be used in practice or testing of embodiments of the invention. Nevertheless, particular methods and materials are described herein for illustrative purposes only. The materials, methods, and examples are not intended to be necessarily limiting.

Accordingly, various embodiments may omit, substitute, or add various procedures or components as appropriate. For instance, it should be appreciated that the methods may be performed in an order different than described, and that various steps may be added, omitted or combined. Also, aspects and components described with respect to certain embodiments may be combined in various other embodiments. It should also be appreciated that the systems, methods, devices, and software may individually or collectively be components of a larger system, wherein other procedures may take precedence over or otherwise modify their application.

### Wireless Power Transfer Systems:

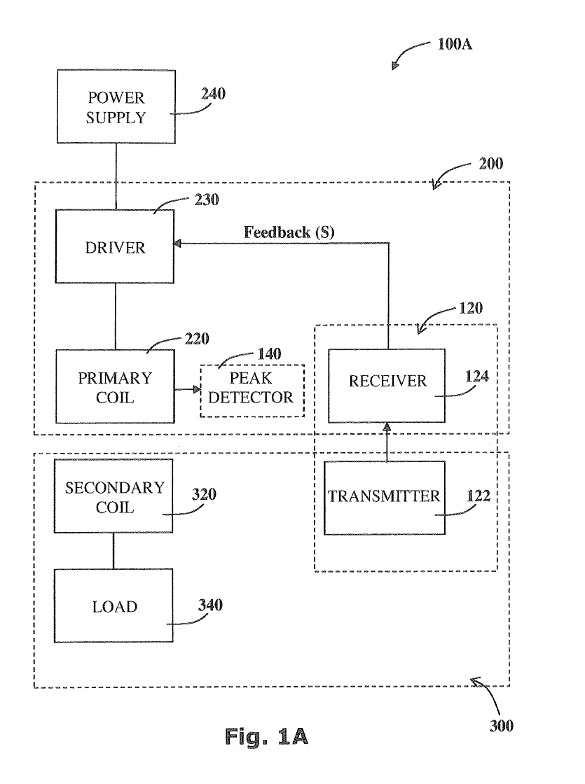

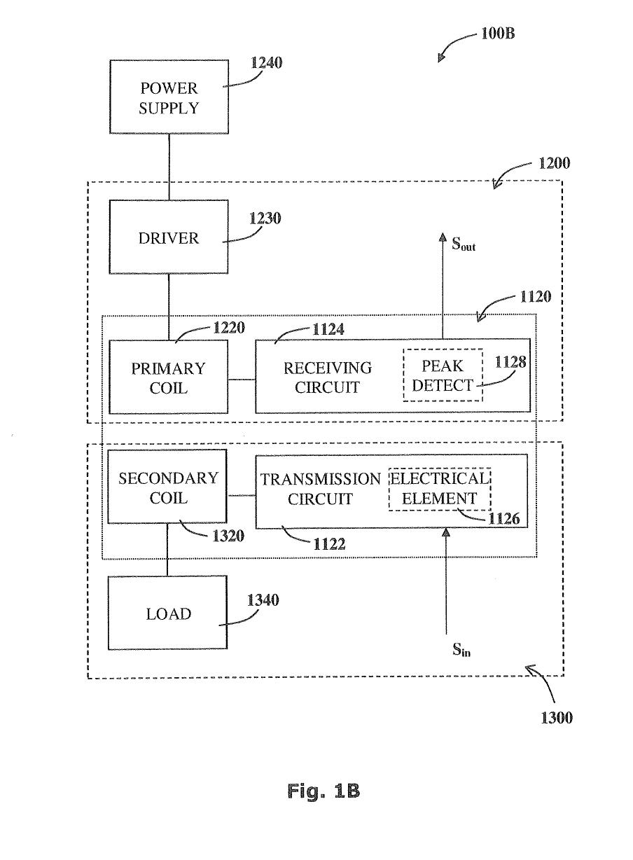

Inductive power coupling allows energy to be transferred from a power supply to an electric load without a wired connection therebetween. When electrical energy is transferred wirelessly from a primary inductor to a secondary inductor, the inductors are said to be inductively coupled. An electric load wired in series with such a secondary inductor may draw energy from the power source wired to the primary inductor when the secondary inductor is inductively coupled thereto. FIG. 1A and FIG. 1B represent various possible embodiments of a wireless power transfer system.

Reference is now made to FIG. 1A, there is provided schematically a block diagram illustrating the main elements of an inductive power transfer system, which is generally indicated at 100A, adapted to transmit power at a non-resonant frequency according to another embodiment of the invention. The inductive power transfer system 100A consists of an inductive power outlet 200 configured to provide power to a remote secondary unit 300. The inductive power outlet 200 includes a primary inductive coil 220 wired to a power source 240 via a driver 230. The driver 230 is configured to provide an oscillating driving voltage to the primary inductive coil 220.

The secondary unit 300 includes a secondary inductive coil 320, wired to an electric load 340, which is inductively coupled to the primary inductive coil 220. The electric load 340 draws power from the power source 240. A communication channel 120 may be provided between a transmitter 122 associated with the secondary unit 300 and a receiver 124 associated with the inductive power outlet 200. The communication channel 120 may provide feedback signals S and the like to the driver 230.

In some embodiments, a voltage peak detector 140 is provided to detect large increases in the transmission voltage. As will be descried below the peak detector 140 may be used to detect irregularities such as the removal of the secondary unit 200, the introduction of power drains, short circuits or the like.

Reference is now made to FIG. 1B, there is provided a block diagram of another embodiment showing the main elements of an inductive power transfer system, which is generally indicated at 100B. It is a particular feature of the current disclosure, shown in certain embodiments of the invention, that an inductive communications channel 1120 is incorporated into the inductive power transfer system 100B for transferring signals between an inductive power outlet 1200 and a remote secondary unit 1300. The communication channel 1120 is configured to produce an output signal Sₒᵤₜ in the power outlet 1200 when an input signal Sᵢₙ is provided by the secondary unit 1300 without interupting the inductive power transfer from the outlet 1200 to the secondary unit 1300.

The inductive power outlet 1200 includes a primary inductive coil 1220 wired to a power source 1240 via a driver 1230. The driver 1230 is configured to provide an oscillating driving voltage to the primary inductive coil 1220, variously at a voltage transmission frequency fₜ which is higher or lower than the resonant frequency f_{R} of the system.

The secondary unit 1300 includes a secondary inductive coil 1320, wired to an electric load 1340, which is inductively coupled to the primary inductive coil 1220. The electric load 1340 draws power from the power source 1240. Where the electric load 1340 requires a direct current supply, for example a charging device for an electrochemical cell or the like, a rectifier 1330 may be provided to rectify the alternating current signal induced in the secondary coil 1320.

An inductive communication channel 1120 is provided for transferring signals from the secondary inductive coil 1320 to the primary inductive coil 1220 concurrently with uninterrupted inductive power transfer from the primary inductive coil 1220 to the secondary inductive coil 1320. The communication channel 1120 may provide feedback signals to the driver 1230.

The inductive communication channel 1120 includes a transmission circuit 122A and a receiving circuit 1124. The transmission circuit 1122 is wired to the secondary coil 1320, optionally via a rectifier 1330, and the receiving circuit 1124 is wired to the primary coil 1220.

The signal transmission circuit 1122 includes at least one electrical element 2126, selected such that when it is connected to the secondary coil 1320, the resonant frequency f_{R} of the system or its quality factor changes. The transmission circuit 1122 is configured to selectively connect the electrical element 1126 to the secondary coil 1320. As noted above, any change in either the inductance L or the capacitance C changes the resonant frequency of the system similarly, any change in the resistance of the system may effectively shift the resonance frequency by changing the quality factor. Optionally, the electrical element 1126 may be have a low resistance for example, with a resistance say under 50 ohms and Optionally about 1 ohm

It is particularly noted that the electrical element 1126, such as a resistor for example, may act to change the effective resonant frequency of the system by damping or undamping the system and thereby adjusting the quality factor of thereof.

Typically, the signal receiving circuit 1124 includes a voltage peak detector 1128 configured to detect large increases in the transmission voltage. In systems where the voltage transmission frequency fₜ is higher than the resonant frequency f_{R} of the system, such large increases in transmission voltage may be caused by an increase in the resonant frequency f_{R} thereby indicating that the electrical element 1126 has been connected to the secondary coil 1320. Thus the transmission circuit 1122 may be used to send a signal pulse to the receiving circuit 1124 and a coded signal may be constructed from such pulses.

According to some embodiments, the transmission circuit 1122 may also include a modulator (not shown) for modulating a bit-rate signal with the input signal Sᵢₙ. The electrical element 1126 may then be connected to the secondary inductive coil 1320 according to the modulated signal. The receiving circuit 1124 may include a demodulator (not shown) for demodulating the modulated signal. For example the voltage peak detector 1128 may be connected to a correlator for cross-correlating the amplitude of the primary voltage with the bit-rate signal thereby producing the output signal Sₒᵤₜ.

In other embodiments, a plurality of electrical elements 1126 may be provided which may be selectively connected to induce a plurality of voltage peaks of varying sizes in the amplitude of the primary voltage. The size of the voltage peak detected by the peak detector 1128 may be used to transfer multiple signals.

### Network API Communication:

The deployment of wireless power transfer infrastructure may enable the provision of convenient access to wireless power transfer in public venues. Accordingly, a smart, manageable, global wireless power transfer network may allow a wider deployment of wireless power provision for mainstream technology and possible standardization of a network architecture and associated APIs. The API of the Power Matters Alliance (PMA), is described hereinafter, as an example.

Reference is now made to FIG. 2, there is provided a system diagram showing a network architecture representation of a wireless power transfer system, which is generally indicated at 200A, operable to use various application interfaces.

It is particularly noted that the network architecture representation 200A, the entities and the associated application interfaces may be used to facilitate standardization of the Application Programming Interfaces (APIs) between the various entities while keeping flexibility to accommodate for innovative approaches.

The network architecture representation 200A includes a first venue architecture 202A, a second venue architecture 202B connectable to a certified device manufacturer (PCDM) 206-1 and a wireless charging spot provider (WCSP) 208-1 through a cloud network service (PCS) 204-1. The first venue architecture 202A and the second venue architecture 202B may further include various network entities.

By way of illustration, in this particular embodiment, the first venue architecture 202A may include a wireless power receiver (Rx) 214A entity connectable to at least one wireless power transmitter (Tx) 216A entity in communication with at least one transmitter gateway (T-GW) 218A entity. The wireless power receiver 214A entity may further be connectable to a User Control Function (UCF) 212A entity. The second venue architecture 202A may include a wireless power receiver 214B, wireless power transmitters 216B, and a transmitter gateway (T-GW) 218B entity in a similar network architecture, possibly differing in the number of network entities, depending on venue servicing capability.

Where appropriate, the wireless power receiver is the entity receiving the power possibly for charging or powering an electrical client device.

Where appropriate, the wireless power transmitter is the entity transmitting the power. Optionally, the wireless power transmitter may be operable to support simultaneously a single power receiver and multiple power receivers.

The term T-GW refers to a Transmitter Gateway function, connecting one or more wireless power transmitter entities to the Internet and serving as an aggregator for multiple wireless power transmitter devices located in a venue.

The term UCF refers to a User Control Function, a logical function providing the user with an interface to the charging service. Accordingly, where appropriate, the UCF is operable to provide a user with services such as searching for wireless charging spot locations, device activation, service subscription, statues monitoring and the like. Optionally, a UCF may be collocated with a power receiver or implemented on a separate device.

The term PCS refers to a cloud service, a centralized system providing cloud service management for the wireless power transfer network.

The term PCDM refers to a certified device manufacture.

The term WCSP refers to a wireless charging spot service providers, ranging from a large-scale provider controlling multiple cross-nation wireless charging spot deployments down to a single wireless charging spot coffee shop.

It is particularly noted that the various network entities are connectable via an associated Application Programming Interface API, applicable to interfacing any two connectable network entities, as described hereinafter

The network architecture representation 200A includes an RX-TX API interface P1 between a wireless power receiver and a transmitter, an RX-UCF API interface P2 between a UCF and a wireless power receiver, a TX-TGW API interface NP5 between a transmitter and a transmitter gateway, a TGW-PCS API interface N1 between a transmitter gateway and a cloud server or network management server, a UCF-PCS API interface N2 between a cloud service or a network management server and a user control function entity, a PCS-WCSP API interface N3 between a cloud service and wireless charging spot service provider, a PCS-PCDM API interface N4 between a cloud service and a certified manufacturer and a UCF API interface S1 for a UCF collocated with an wireless power receiver.

It is noted that where appropriate the RX-UCF API interface P2 may not be required depending on the wireless power receiver type, allowing for support of embedded UCF function as well as aftermarket add on. Accordingly, the P2 API may be technology agnostic.

It is further noted that the TX-TGW API interface NP5 may be an open interface left for vendor specific implementation.

The TGW-PCS API interface N1 may be an IP based interface supporting initial provisioning and initialization of a wireless power transmitter and a T-GW, continuous usage reporting between the two entities and continuous provisioning and policy settings for a wireless power transmitter connected to a T-GW. Support of admission and change control for wireless power receiver devices coupled with the controlling of a wireless power transmitter is further included.

The UCF-PCS API interface N2 may be an IP based interface carried over OOB bearer services of the UCF (cellular WLAN etc.). Optionally, the interface N2 may be carried via the wireless charging receiver and transmitter. The UCF-PCS API interface N2 may support charging and service subscription provisioning including billing information where required, charging status reporting and charging spot location data. Additionally, target value messaging from a service provider via PCS may further be supported. Examples of messages for the UCF-PCS API interface N2 are presented below.

The PCS-WCSP API interface N3 may be an IP based interface supporting WCSP initial and continuous provisioning and monitoring of its network entities (Transmitter and T-GW), admission policy settings for power receiver on the different power transmitter devices and usage information combined with statistics on different power transmitter and power receiver devices. The PCS-WCSP API interface N3 further supports handling of power receiver subscription (support for centralized or path-through models for subscription and billing info handling) and policy and usage based targeted messaging configuration.

The PCS-PCDM API interface N4 may support registration of power receiver identifiers (RXIDs) and registration of certified power transmitter identifiers (TXIDs). This interface may allow certified OEMs/ODMs to pre-register their devices with the PCS. Registration may be via a registration form providing company and device details as required.

The UCF API S1 internal interface may provide a set of software API for specific OS that allows application layer for accessing power receiver information exposed via the RX-UCF API interface P2. For example, for Android, these may be, inter alia, the APIs for Dalvik application accessing RXID information and power receiver registers or the like. The internal interface may provide for an API to Java like applications to accessing power receiver resources on the platform.

By the way of a non-limiting example, provided for illustrative purposes only, an interface may be described for the Android OS platform, other examples will occur to those skilled in the art. Regarding the Android interface, most of its application written in Java, the Java Virtual Machine is not used, rather another API, the Dalvik API, is used. Similar APIs may be defined for other leading OS in the consumer electronics space.

The API may allow UCF applications development that is abstracted from the specific hardware implementation.

With regard to TGW-PCS API, interface N1 may enable communication between the network management server and satellite elements such as wireless power outlets, communication modules, gateway modules and the like. The TGW-PCS API interface N1 may use an application programming interface (API) for example based on JavaScript Object Notation (JSON), Extensible Markup Language (XML) or the like. Accordingly the network management server may remotely manage the satellite elements.

The TGW-PCS API interface N1 or network messaging protocol may include various messages used for network management such as messages providing tools for maintaining the health, configuration, and control of a Power Module (PM) or wireless power outlet; messages for health and configuration of a Communication Module (CM); or access authorization messages for a new network element such as a power transmitter to join the wireless power transfer network.

Communication security may be provided by using secure communication channels such as an HTTPS connection. Furthermore, communication may include MAC address filtering using transmitter identification codes (TXID), receiver identification codes (RXID), gateway identification codes (GWID) and the like to control network access. Accordingly, TXIDs may be preregistered with the network management server and before the associated power outlet is authorized to join the network and communication is enabled.

Network messages may include a version number uniquely identifying the message format. This may enable a network management to be backward compatible and able to communicate with satellite elements such as power outlets using multiple versions of the communication protocol.

Messages may be further labeled by time stamps and a sequential message identification code (message ID) such that received messages may be validated. For example, a message timestamp may be reported as UTC time zone such that messages sent to the network server may be filtered by time. Accordingly, recent messages may be processed whereas old messages and messages with future time stamps may be ignored.

According to another validation method, the timestamp and message ID may be compared as a check that the messages are sent in sequential order. For example, if a message with a timestamp older than a previous message is sent for a transmitter, the message is ignored. Thus if message n with timestamp of 4:30:50 is received after message n+1 with the earlier timestamp of 4:30:10, message n is ignored, similarly if message n+1 with timestamp of 4:29:10 is received after message n with timestamp of 4:29:40, message n+1 is ignored.

Examples of various communication message types which may be used as appropriate include the following:

Status Report Messages which may be sent to a management server by a wireless power outlet periodically, upon request or ad hoc to report the wireless power outlet's charging status, the ID of a coupled power receiver, and operational errors.

Extended Status Report Messages may be sent to a management server by a wireless power outlet in response to a request from the management server network to provide hardware-dependent diagnostic information.

Status Response Messages which may be sent from a management server to the wireless power outlet in response to a Status Report Message or Extended Status Report Message to provide control commands to instruct the power outlet to execute certain actions.

Configuration Report Messages which may be sent to a management server by a wireless power outlet periodically or when instructed to do so in a Response Message. The Configuration Report Message may provide information to the network manager regarding hardware and software of the power outlet.

Configuration Response Messages which may be sent from a management server to the wireless power outlet in response to a Configuration Report Message to provide configuration commands to instruct the power outlet to execute certain actions pertaining to configuration such as software updates and the like.

Health Status Report Messages which may be sent to a management server by a communication module periodically, when instructed to do so, or ad hoc to provide health status to the network management server.

Health Status Response Messages which may be sent from a management server to a communication module in response to a Health Status Report Message and provide control commands to instruct the communication module to execute certain actions.

Gateway Configuration Report Messages which may be sent to a management server by a communication module periodically, when instructed to do so, or ad hoc. The Configuration Report Message may provide information to a network manager regarding hardware and software of the communication module.

Gateway Configuration Response Messages which may be sent from a management server to the communication module in response to a Gateway Configuration Report Message to provide configuration commands to instruct the wireless power outlet to execute certain actions pertaining to configuration such as firmware updates, software updates, clearing cache, rebooting, archiving logs, setting defaults such as log sizes and the like.

Join Request Messages which may be sent to a management server by a communication module to provide details of a candidate wireless power outlet to be added to the network.

Join Request Response Messages which may be sent from a management server to a communication module in response to Join Request Messages to authorize the addition of the candidate wireless power outlet to the network or to reject the candidate power outlet.

### The Wireless Power Modem:

A control or a management server may be in communication with a wireless power outlet or a wireless power receiver associated with an electrical device to enable various remote functions such as remote power provisioning, remote maintenance, remote health check, remote upgrade and the like. Commonly, a wireless power outlet may comprise two main elements; a charging element and a communication element, enabling the wireless power outlet to communicate with a centrally managed control server via the communication element.

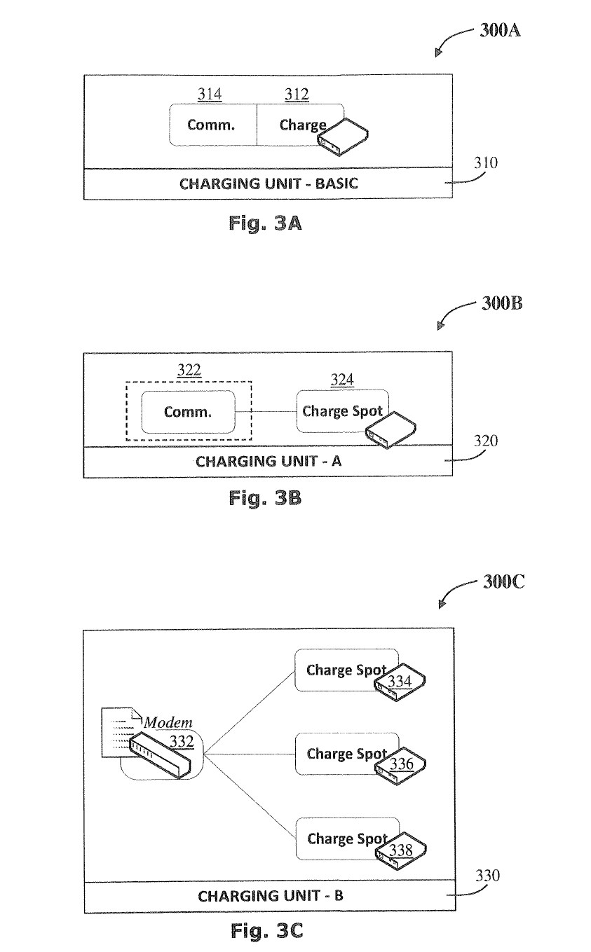

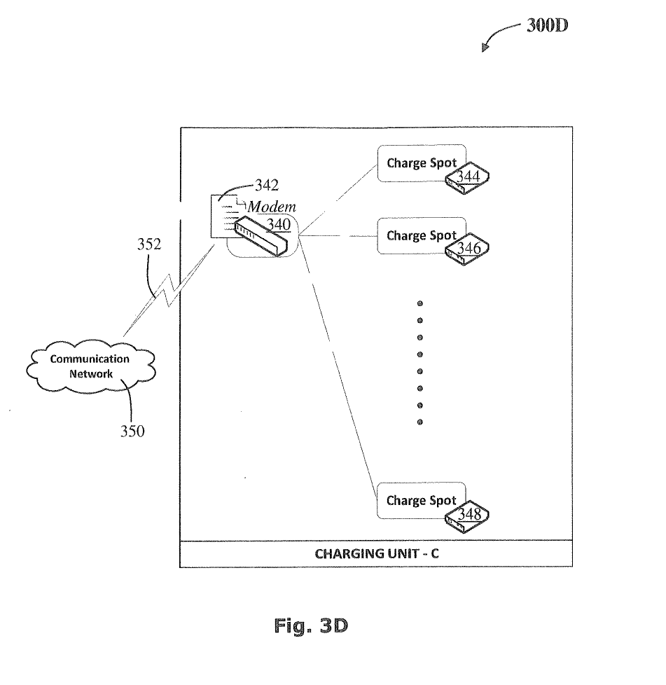

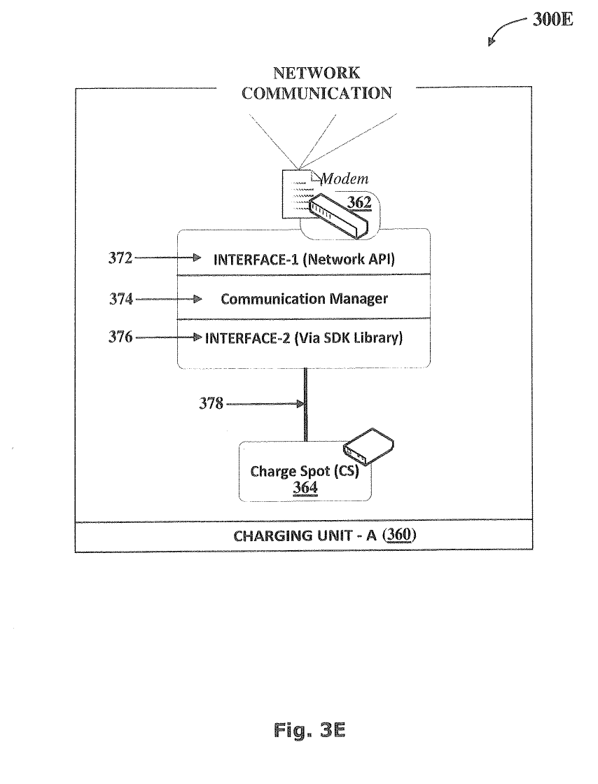

Accordingly, FIGS. 3A-B represent a block diagram schematically illustrating various possible configurations of a wireless power transfer unit, whereas FIG. 3C is a block diagram schematically illustrating a possible configuration of a wireless power transfer unit according to the present invention.

As illustrated in FIG. 3A, the wireless power outlet 310 is an integrated unit comprising a charging element 312 and a communication element 314, representing a one communication element for one charging element (1:1 ratio).

Another possible embodiment of a wireless power outlet is illustrated in FIG. 3B, separating the wireless power outlet into two distinct elements. Thus, the wireless power outlet 320 comprising a charging element 322 and a separate communication element 324 providing more flexibility in installing the power outlet, but keeping a one communication element for one charging element ratio.

It is noted that the wireless power outlet may be hosted in one physical unit. Optionally, the charging element and the communication element may each be hosted in a different physical unit, wherein the charging element may be wired to the communication element. Additionally or alternatively, the communication element may be wirelessly connected to the charging element.

The current disclosure enables a single communication element to manage a plurality of charging elements (wireless power outlets/charging spots) as illustrated in FIG. 3C. The charging power unit 330, a table in public places, for example, comprises three wireless power outlets 334, 336 and 338 manageable and controlled via a wireless power modem 332, representing a one to many ratio - one communication element controlling multiple charging element architecture.

Reference is now made to FIG. 3D, there is provided a block diagram schematically representing a wireless power transfer system, which is generally indicated at 300D, of a wireless power modem managing a set of wireless power outlets via a communication module. The system 300D includes a wireless power modem 340 configured to execute a network module 342 and operable to manage and control a plurality of wireless power outlets (charging units) such as 344, 346 through to 348. The system may manage, up to say 16 charging spots, by a communication network 350 such as the Internet through a communication channel 352 using an Application Programming Interface (API) communicating a set of associated messages as described hereinafter, FIGS. 7A-L.

Reference is now made to FIG. 3E, there is provided a block diagram schematically representing a possible architecture, which is generally indicated at 300E, of a wireless power modem and an associated wireless power outlet for providing wireless power transfer services to electrical mobile devices operable in various power transfer protocols.

The architecture block diagram 300E represent a possible wireless power unit 360, including a wireless power modem 362 and at least one wireless power outlet 364.

It is noted that although the drawing shows a one wireless power outlet 364, it is a representative element of a possible set of plurality of wireless power outlets controlled and manageable via the wireless power modem 362.

Accordingly, the wireless power modem comprises a first interface 372, operable to communicate with a networked control server, for example, via a communication network. The wireless power modem further comprises a communication manager 374 configured to control one or more of the plurality of wireless power outlets a second interface 376 as a pre-determined power-protocol interface of a power-transfer software development kit (SDK), enabling to interface with the power transfer protocol associated with the selected wireless power outlet being operated (wireless power outlet 364, for example).

It is noted that the power-transfer software development kit (SDK) may provide implementations of the pre-determined interface, such that the wireless power modem may be configured to control various power transfer protocols such as PMA, A4WP, Qi of WPC, MIMO or other third party power-transfer protocols.

It is further noted that the power-transfer software development kit (SDK) may include a library of pre-determined power-protocol interfaces, and a power-protocol interface selector for selecting a power-protocol interface specific to the power transfer protocol associated with the selected wireless power outlet being operated.

### Venue System Deployment:

As illustrated in FIGS. 4A-E, there is provided various aspects representations of venue deployment and possible internal wireless power outlets distribution. Each wireless power outlet associated with a venue may use different power transfer protocols such as a Power Matters Alliance (PMA), an Alliance for Wireless Power (A4WP), a Qi of Wireless Power Consortium (WPC), a Beam Forming protocol (multiple input, multiple output, MIMO), a third party associated power-transfer protocol and the like.

In such network distribution, the communication channel may be mediated by wireless access points, cellular networks, wired networks or the like that may provide an internet protocol (IP) connection to at least one of the electrical devices or the wireless power outlet. It is further noted that optionally, the communication channel to the wireless power outlet may be mediated indirectly via the electrical device and the close communication module. Similarly, the communication channel to the electrical device may be mediated indirectly via the wireless power outlet.

FIG. 4A provides a schematic overview of a possible servicing venue deployment for providing wireless power transfer services to electrical mobile devices operable in various power transfer protocols. FIG. 4B-C represent expanded illustration views of a venue controlled via one wireless power modem. FIGS. 4D-E represent expanded illustration views of a venue controlled via two wireless power modems, where the communication of a wireless power modem to the centrally managed control server is via at least one venue gateway (FIG. 4D). Alternatively each wireless power modem may communicate directly with the centrally managed control server (FIG. 4E).

Reference is now made to FIG. 4A, there is provided a network layout schematically representing selected components of a possible servicing venue deployment, which is generally indicated at 400A, for providing wireless power transfer services to electrical mobile devices operable in various power transfer protocols. The power management system may provide a system interface operable to communicate with electrical devices of various power transfer protocols such as of Power Matters Alliance (PMA), Alliance for Wireless Power (A4WP), Qi of Wireless Power Consortium (WPC), Beam Forming protocol (multiple input, multiple output, MIMO), a proprietary third party power transfer technology and the like, via a common Software Development Kit (SDK). The power-transfer SDK provides a common interface, while applying internally the communication interface according to the electrical device. For example, the power-transfer SDK engine may be operable to communicate with a PMA electrical device using an interface such as P5 interface for controlling a wireless power outlet (see FIG. 2).

It is noted that the power-transfer SDK engine may be configured to use various interfaces, such as N1 interface (see FIG. 2) for communicating with a venue gateway. Optionally, the power-transfer SDK engine may further be configured to use N2 interface (see FIG. 2) and enable user interactions.

The wireless power outlet deployment 400A comprises a set of wireless power transfer venues 411A-G, each venue may be associated with at least one wireless power modem 401A-G, depending on venue layout arrangement. Each wireless power modem may be in communication with a central management server 430 via a communication network 420.

It is noted that each wireless power outlet may be associated with and identification code, a TxID (Transmitter ID). Optionally, the TxID identification code may be used by the wireless power modem to determine the power transfer protocol of the wireless power outlet, such that the underlying power-transfer SDK engine is operable to communicate properly with the device.

It is further noted that the wireless power outlet may be referred to as a Hotspot, a Charging Spot (CS) and the like.

As illustrated in FIG. 4B, there is provided a system distribution, which is generally indicated at 400B, for providing power wirelessly to electrical devices. The system distribution comprises a set of venues 412A, 412B, 412C each associated with at least one wireless power modem 402A, 402B and 402C for managing and controlling wireless power transfer from wireless power outlets of the venue.

The venue 412B is shown in an expanded manner and includes a wireless power modem 402A, a wireless power outlet 432 (operable under PMA associated power transfer protocol, for example), a wireless power outlet 434 (operable under A4WP associated power transfer protocol, for example) and a wireless power outlet 436 (operable under a third party associated power transfer protocol, for example). The various wireless power outlets 432, 434, 436 may be accessible and controlled via the wireless power modem 402A using a power-transfer SDK 422 providing transparent access to each outlet regardless of the power transfer protocol associated with the outlet.

It is particularly noted that the set of wireless power outlets of a venue may be fully configured under a specific power transfer protocol. Additionally or alternatively the set of wireless power outlets of a venue may use a mixture of associated power transfer protocols, with at least one wireless power modem operable to control the wireless power provisioning and associated functionalities, regardless of the associated power transfer protocol.

Similarly, as illustrated in FIG. 4C, there is provided a system distribution, which is generally indicated at 400C, for providing power wirelessly to electrical devices. The system distribution comprises a set of venues 413A, 413B, 413C, 413D each associated with at least one wireless power modem 403A, 403B, 403C and 403D for managing and controlling wireless power transfer from wireless power outlets of the venue. Venue 413A and venue 413B are shown in an expanded manner and the associated wireless power modems 403A and 403B are accessible via the communication network 420 using API 424. The wireless power modem 403A of venue 413A is in communication with the associated wireless power outlets 432A, 434A and 436A via the SDK interface, according to its associated power transfer protocol. Accordingly, the wireless power modem 403B of venue 413B is in communication with the associated wireless power outlets 432B, 434B and 436B via the power-transfer SDK interface, according to its associated communication protocol.

As illustrated in FIG. 4D, there is provided a system distribution, which is generally indicated at 400D, for providing power wirelessly to electrical devices according to an associated power transfer protocol. The system distribution comprises a venue gateway 435, a set of venues 414A, 414B each comprising at least one wireless power modem for managing and controlling wireless power transfer from wireless power outlets of the venue. Venue 414A, further comprises a wireless power modem 404-1 controlling a first set of wireless power outlets 406a (power outlets 432C, 434C, 436C) and a wireless power modem 404-2 controlling a second set of wireless power outlets 406b (outlets 432D, 434D, 436D). Venue 414B is associated the wireless power modem 404B and venue 414C is associated the wireless power modem 404C.

The wireless power modems 404-1 and 404-2 are accessible via the communication network 420 and the venue gateway 435 using API 424. Each wireless power modem of Venue 414A is operable to communicate with the associated wireless power outlets via the power-transfer SDK interface 422, according to its associated power transfer protocol.

Further, as illustrated in FIG. 4E, there is provided a system distribution, which is generally indicated at 400E, for providing power wirelessly to electrical devices. The system distribution comprises a set of venues 415A, 415B, 415C each associated with at least one wireless power modem 405A, 405B and 405C for managing and controlling wireless power transfer from wireless power outlets of the venue. Venue 415A, further comprises a wireless power modems 405-1 controlling a first set of wireless power outlets 407a (outlets 432E, 434E, 436E) and a wireless power modems 405-2 controlling a second set of wireless power outlets 406 (outlets 432F, 434F, 436F).

Differently, as compared to the layout of FIG. 4D, the wireless power modems 405-1 and 405-2 of FIG. 4E are accessible directly via the communication network 420 using the API 424 and not through a venue gateway. Each wireless power modem network of Venue 415A is operable to communicate with the associated wireless power outlets via the SDK interface 422, according to its associated power transfer protocol.

### Power-Transfer SDK Layers:

Reference is now made to FIG. 5, there is provided a block diagram schematically representing a possible layer structure, which is generally indicated at 500, of a power-transfer Software Development Kit (SDK) engine of the wireless power modem.

Generally, an SDK is a collection of software elements (libraries, functions, methods, commands, header files and the like) used to develop software applications. Specifically, the power-transfer SDK associated with the wireless power modem enables to develop a software package installed on the wireless power modem device to provide connectivity between the wireless power modem and the outlet according to the desired power transfer protocol. Thus, one single wireless power modem is operable to manage and control a plurality of wireless power outlets of operable at various technology standards such as PMA, A4WP, Qi of WPC, MIMO, third party and the like.

Accordingly, the power-transfer software development kit (SDK) may include a library of pre-determined power-protocol interfaces, and a power-protocol interface selector for selecting a power-protocol interface specific to the power transfer protocol associated with the selected wireless power outlet being operated.

The layer structure 500 of the power-transfer Software Development Kit (SDK) engine may comprise a software network interface layer 522 accessible according to the exposed network interface definitions by an application program running (API), a selecting layer 524 operable to process the communications and acts as a transparent layer selecting the specific power transfer protocol underlying layer—a first power transfer layer 526 a PMA layer, for example, a second power transfer layer 528 an A4WP layer, for example, and a specific layers for a third party power transfer protocol layer 530. The power-transfer SDK engine further comprises a command generation layer 532 configured to generate the appropriate commands, depending on the currently available power transfer protocol for a specific wireless power outlet and an communication layer 534 configured to manage the communication with the various wireless power outlets.

It is noted that a wireless power outlet may be operable to be wired to a wireless power modem parent. Optionally, a wireless power outlet may be configured to communicate wirelessly with a wireless power modem parent.

### Wireless Power Modem Provisioning Control:

Reference is now made to FIG. 6A, there is provided a flowchart representing selected actions illustrating possible method, which is generally indicated at 600A, for initiating the communication to control a specific wireless power outlet of a power transfer protocol such as PMA, A4WP or any other third party associated power transfer protocol supported. The method 600A covers the initiation phase of communication with the desired wireless power outlet, prior to the control phase of the wireless power outlet throughout the power provisioning phase.

The method 600A may be triggered by a management server receiving a communication signal—step 610, as a communication initiation, from a wireless power receiver. Optionally the communication signal may be received directly from the wireless outlet; the communication signal may be followed by receiving a power outlet identification code—step 612; and sending the power outlet identification code to the associated wireless power modem—step 614; receiving the power outlet identification code by the wireless power modem—step 616; determining the associated power transfer protocol of the associated wireless power outlet—step 618; and setting the initial communication parameters—step 620, for further communication with the power outlet for control of the power provisioning phase.

Reference is now made to the flowchart of FIG. 6B representing selected actions illustrating possible method 600B for controlling a specific wireless power outlet associated with a technology standard such as PMA, A4WP, WPC, MIMO or other third party power-transfer protocols supported. Such a method may cover the control phase of communication to manage wireless power provisioning.

The method 600B may be triggered by a management server generating a power associated command associated with power provisioning control—step 622, based upon previous communications received from a power receiver. Optionally the communications signal may be received directly from the wireless outlet; sending the generated power command to the associated wireless power modem—step 624, as identified by previous communications; receiving the power provisioning command—step 626, by the wireless power modem; selecting the associated power transfer protocol interface—step 628 for the associated wireless power outlet, according to the power transfer protocol as determined in the initiation phase; generating the internal power provision command—step 630 according to the associated power transfer protocol associated with the power outlet; sending the generated provisioning command—step 632 to the selected power outlet; thereafter, receiving a response message for the command—step 634 from the selected wireless power outlet; and sending the response—step 636, to the management server.

### The Network Module:

A wireless power modem such as described hereinabove (such as item 340, FIG. 3D) may be configured to execute a network module operable to control a plurality of wireless power outlets (charging units/charging spots) through a communication network such as the Internet.

A network module installed on such a wireless power modem is operable to connect with say, 16 charging units over the network, as illustrated in FIG. 3D, controlling various aspects of each charging unit, using an Application Programming Interface (API) communicating a set of associated messages as described hereinafter.

The API supports one connected charging unit per network module. Additionally or alternatively, a plurality of charging units may be connected per a network module. The API and messages between the network module associated with a wireless power modem and the charging units is further described hereinafter.

The communication flow between a network module and a charging spot may be configured in various operational modes, such as a polling driven mode, an event driven mode and the like.

In a polling driven mode, the network module may be continuously sending “get status” commands every a certain amount of milliseconds to any of the connected charging spots and further wait for an associated response. All other data may be collected by the network module as requested by the system.

In an event driven mode, the network module may be requesting for data as needed. Additionally, the charger spot may send a “status changed” message whenever its status is being changed.

It is noted that when the system is operable to control a single charging unit per network module, both modes may be used as described hereinabove. Controlling a plurality of charging units per network module, using the event driven mode may require the addition of an anti-collision mechanism.

Optionally, for both operational modes, the charging unit may need to respond to any of the network module requests within a preconfigured time interval, say within five milliseconds from the end of the request message.

Various parameters may be exchanged between the wireless power modem and the wireless power outlets, and further externally via the network. The Parameters may be as follows:
TxID parameter, determines the MAC ID of the charger unit, 6 bytes long and value range may be between 0x000000000000-0XFFFFFFFFFFFF.
RxID parameter, determines the MAC ID of the charged receiver, 6 bytes long and value range may be between 0x000000000000-0XFFFFFFFFFFFF.
Charger status parameter, determines the charger status, 1 byte long and may have a value of: idle 0x00, charging 0x01, End of Power (EOP) 0x02, Rx removed 0x03 and occupied (not charging) 0x31.
Error type parameter, determines type of active error state, 1 byte long and may have a value of: No Error 0x00, RxID error 0x04, Charging disabled (by cloud) 0x05, Temperature limits Exceeded 0x06, Current limits Exceeded 0x07, Voltage limits exceeded 0x08 and Charger HW Failure 0x40.
Error parameter, determines extended information according to the status of error type, 1 byte long and may have a value of: Status 0x00-0x00, Status 0x01-0x00, Status 0x02-0x00, Status 0x03-0x00, Status 0x31-0x00—other, —0x01—FOD, 0x02—No Data, —0xF0—TTC, Error 0x00-0x00, Error 0x04-0x00, Error 0x05—EOP reason, Error 0x06—Temperature value, Error 0x07—Current value, Error 0x08—Voltage Value, Error 0x40-0x00.
Pout parameter, determines the power supplied to the receiver device, from last report, in mili-watts, sent MSB first, 2 bytes long, ranging from 0x0000 to 0xFFFF.
FW Version, determines the charger firmware version, 2 bytes long and may have value ranges of 0x00 to 0xFF.
   HW Version, determines the charger hardware version, 2 bytes long and may have value ranges of 0x00 to 0xFF.
   Charge Enable/Disable parameter, being sent from the network unit for enabling or disabling wireless power transfer.

The FIGS. 7A-L represent various communication messages and responses of the network API used in a system managing a plurality of wireless power outlets. It is particularly noted that the communication message and responses are presented by way of non-limiting example and may vary accordingly.

Reference is now made to FIG. 7A, there is provided a general schematic communication message format, which is generally indicated at 700A, for determining the message content for a specific communication according to one embodiment of the invention. The general schematic communication message format 700A includes:

a preamble field 702A defining the start of message and is of 1 byte long and a possible value of 0x55;

a Tx/Rx (Receiver/Transmitter) Address field 702B defined by the high nibble, the address of the message sender and by the low nibble, the address of message receiver and is of 1 byte long and a possible value of 0x0 for the network unit and 0x1 for the first charging unit;

a Length field 702C defining the message length including ‘Version’, ‘Header’, and ‘Payload’ fields and is of 1 byte long within the range of 0x00-0x3F, where 2 MSB (most significant bit) are reserved for future use;

a Version field 702D defining the protocol version and if is of 1 byte long with possible value of 0x00;

a Header field 702E defining the message name and is of 1 byte long with a possible values in the range of 0x00-0xFF;

a Payload field 702F defining the message payload and is of 0-63 bytes long and may have various possible values of 0x00-0xFF*Size; and

a CRC16 field 702G defining the message CRC16-CCIT and is of 2 bytes long with a possible value within the range of 0x0000-0xFFFF.

As used herein, CRC (cyclic redundancy checking) is a method of checking for errors in data that has been transmitted on a communications link. A sending device applies a (16 or 32 bit) polynomial to a block of data that is to be transmitted and appends the resulting cyclic redundancy code (CRC) to the block. The receiving end applies the same polynomial to the data and compares its result with the result appended by the sender. If they agree, the data has been received successfully. If not, the sender can be notified to resend the block of data.

It is noted that the setting of the Header field value indicates the type of communication message (request and response). For example, a header value of 0x01 may indicate a “get TxID” communication message; a header value of 0x02 may indicate a “get RxID” communication message; a header value of 0x03 may indicate a “get status” communication message; a header value of 0x04 may indicate a “get version” communication message; a header value of 0x05 may indicate a “set charging” communication message; and a header value of 0x60 may indicate a “status change” communication message.

As illustrated, in FIG. 7B, there is provided a schematic communication message request for a “get TxID”, which is generally indicated at 700B, asking the charging unit to send its MAC ID. The request is indicated by the value of the Header field 704E with the value of 0x01.

As illustrated, in FIG. 7C, there is provided a schematic communication message response for the “get TxID” (the request as described in FIG. 7B), which is generally indicated at 700C, providing the requested response of the TxID (the MAC ID), determined in the payload response field of 6 bytes long (bytes 706F through 706K).

It is noted that the “get TxID” communication message response may be indicated by a value of 0x01 in the header field, the same value of the associated communication message request (FIG. 7B).

As illustrated, in FIG. 7D, there is provided a schematic communication message request for a “get RxID”, which is generally indicated at 700D, asking the charging unit to send the MAC ID of the charged receiver unit. The request is indicated by the value of the Header field with the 0x02.

As illustrated, in FIG. 7E, there is provided a schematic communication message response for the “get RxID” (the request as described in FIG. 7D), which is generally indicated at 700E, providing the requested response of the RxID (the MAC ID), determined in the payload response field (bits 710F through 710R). The bit 710F provides the number of Rx's included in the response, thereafter the bits 710G to 710L provide the details of the first Rx(1) of the response, the bits 710M to 710R provide the details of the Rx(N) in the response.

It is noted that a “get RxID” communication message response may be indicated by a value of 0x02 in the header field, the same value of the associated communication message request (FIG. 7D).

As illustrated, in FIG. 7F, there is provided a schematic communication message request for “get status”, which is generally indicated at 700F, asking the charging unit to send a status and an associated error report. The request is identified as a status request by submitting the value of 0x03 in the Header field.

As illustrated, in FIG. 7G, there is provided a schematic communication message response for “get status” (the request as described in FIG. 7F), which is generally indicated at 700G. The requested response 700G for the get status request is determined in the payload response field (bits 714F through 714H). The byte 714F provides the status byte response, the byte 714G provides the error byte response and the byte 714H provides the error data details in the response.

It is noted that a “get status” communication message response may be indicated by a value of 0x03 in the header field, the same value of the associated communication message request (FIG. 7F).

It is further noted that the charging unit status parameter configured to determines the charging unit status is of 1 byte long and may have a value of: idle 0x00, charging 0x01, End of Power (EOP) 0x02, Rx removed 0x03 and occupied (not charging) 0x31. Furthermore, the error type parameter may determine the type of active error state, 1 byte long and may have a value of: No Error 0x00, RxID error 0x04, Charging disabled (by cloud) 0x05, Temperature limits Exceeded 0x06, Current limits Exceeded 0x07, Voltage limits exceeded 0x08 and Charger HW Failure 0x40. Moreover, the error parameter, determines extended information according to the status of error type, 1 byte long and may have a value of: Status 0x00-0x00, Status 0x01-0x00, Status 0x02-0x00, Status 0x03-0x00, Status 0x31-0x00—other, —0x01—FOD, 0x02—No Data, —0xF0—TTC, Error 0x00-0x00, Error 0x04-0x00, Error 0x05—EOP reason, Error 0x06—Temperature value, Error 0x07—Current value, Error 0x08—Voltage Value, Error 0x40-0x00.

As illustrated, in FIG. 7H, there is provided a schematic communication message request for getting associated versions, which is generally indicated at 700H, asking the charging unit to send its hardware version and its firmware version. The request is identified as a get version request by submitting the value of 0x04 in the Header field.

As illustrated, in FIG. 7I, there is provided a schematic communication message response for “get version” request (the request as described in FIG. 7H), which is generally indicated at 700I. The requested response 700I for the “get version” request is determined in the payload response field (bits 718F through 718I). The bit 718F provides the high bit of the firmware version and the bit 718G of the message response Similarly, the bit 718H provides the high bit of the hardware version and the bit 718I of the message response provides the low bit response.

It is noted that a “get version” communication message response may be indicated by a value of 0x04 in the header field, the same value of the associated communication message request (FIG. 7H).

As illustrated, in FIG. 7J, there is provided a schematic communication message request for set charging, which is generally indicated at 700J, asking the charging unit to enable/disable the charging. The request is identified as a set charge request by submitting the value of 0x05 in the Header field 720E and providing the desired parameter of enable/disable in the payload field 720F.

As illustrated, in FIG. 7K, there is provided a schematic communication message response for “set charging” request (the request as described in FIG. 7J), which is generally indicated at 700J.

It is noted that a “set charging” communication message response may be indicated by a value of 0x05 in the header field, the same value of the associated communication message request (FIG. 7J).

As illustrated, in Fig. L, there is provided a schematic communication message indicating status change, which is generally indicated at 700L. The status change message 700L is communicated by the charging unit each time the status of the associated charging unit is changed, and is shown in bits of the payload field (bits 722F through 224H). The bit 722F provides the status bit in the communication, the bit 722G provides the error bit in the communication and the bit 722H provides the error data details in the communication.

It is noted that a “status change” communication message may be indicated by a value of 0x60 in the header field.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%. The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims.

Additionally, the various embodiments set forth hereinabove are described in terms of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A system for controlling a wireless power transfer network, said system comprising:
a plurality of wireless power outlets operable to transfer power to at least one electrical device associated with a wireless power receiver, each of said plurality of wireless power outlets being configured to power said at least one electrical device using
an associated power transfer protocol; and
at least one wireless power modem in communication with one or more of said plurality of wireless power outlets, said at least one wireless power modem being operable to execute instructions directed to:
receiving an identification code, said identification code comprising data pertaining to the power transfer protocol associated with a selected wireless power outlet; and
controlling wireless power transfer from the selected wireless power outlet,
wherein said at least one wireless power modem comprises:
a power-outlet communication manager configured to control one or more of said plurality of wireless power outlets; and
a power-transfer software development kit (SDK) including a library of predetermined power-protocol interfaces, and a power-protocol interface selector for selecting a power-protocol interface specific to the power transfer protocol associated with the selected wireless power outlet being operated.

2. The system of claim 1, wherein said power-transfer SDK comprises a set of tools configured to provide a dedicated layer for each said associated power transfer protocol to enable interfacing according to said power-protocol interface.

3. The system of claim 1, wherein said at least one wireless power modem is accessible from a communication network via a network communication interface.

4. The system of claim 1, wherein said identification code is being received from said at least one wireless power outlet.

5. The system of claim 1, wherein said identification code is being received from said wireless power receiver.

6. The system of claim 1, wherein said identification code is being received from a centrally managed control server.

7. The system of claim 1, wherein said associated power-transfer protocol is selected from the group consisting of a non-resonance power transfer technology, a resonance power transfer technology, a magnetic multiple-input multiple-output (MIMO) power transfer technology, an inductive power transfer technology, and a conformable third party proprietary technology.

8. The system of claim 1, wherein each of said plurality of wireless power outlets is connectable to said at least one wireless power modem via a wired connection.

9. The system of claim 1, wherein each of said plurality of wireless power outlets is connectable to said at least one wireless power modem wirelessly.

10. The system of claim 3, wherein said network communication interface is selected from the group consisting of a proprietary Application Programming Interface (API), a Zigbee interface, a WiFi interface, and combinations thereof.

11. A wireless power modem configured to control a plurality of wireless power outlets, each of said plurality of wireless power outlets being operable to power at least one electrical device using an associated power transfer protocol,
wherein said wireless power modem is configured to selectively operate at least one of said plurality of wireless power outlets according to said associated power transfer protocol, and
wherein said wireless power modem comprises:
a power-outlet communication manager configured to control one or more of said plurality of wireless power outlets; and
a power-transfer software application kit (SDK) including a library of predetermined power-protocol interfaces, and a power-protocol interface selector for selecting a power-protocol interface specific to the power transfer protocol associated with the wireless power outlet being operated.

12. The wireless power modem of claim 11, wherein said wireless power modem is accessible from a communication network via a network communication interface.

13. The wireless power modem of claim 12, wherein said network communication interface is selected from the group consisting of a proprietary Application Programming Interface (API), a Zigbee interface, a WiFi interface, and combinations thereof.

14. The wireless power modem of claim 11, further comprising a plurality of connectors for connecting to each of said plurality of wireless power outlets via a wired connection.

15. The wireless power modem of claim 11, further comprising a wireless communicator for connecting to each of said plurality of wireless power outlets wirelessly.

16. The wireless power modem of claim 11, wherein said associated power transfer protocol is selected from the group consisting of a non-resonance power transfer technology, a resonance power transfer technology, a magnetic multiple-input multiple-output (MIMO) power transfer technology, an inductive power transfer technology, and a conformable third party technology.

17. A method for controlling a wireless power transfer system, said wireless power system comprising:
at least one wireless power outlet configured to power at least one electrical device using an associated power transfer protocol;
at least one wireless power modem in communication with said at least one wireless power outlet; and
at least one control server in communication with said at least one wireless power modem via a network communication interface, said method comprising:
receiving an identification code, said identification code comprising data pertaining to the power transfer protocol associated with a selected wireless power outlet;
selecting a pre-determined power-protocol interface from a library of a power-transfer software application kit (SDK), said power-protocol interface specific to the power transfer protocol associated with the selected wireless power outlet; and
controlling wireless power transfer from the selected wireless power outlet.

18. The method of claim 17, wherein said controlling wireless power transfer comprises:
receiving at least one power command comprising data pertaining to controlling said at least one wireless power outlet; and
executing an associated power command of an interface layer of the selected pre-determined power-protocol interface.

19. The method of claim 17, wherein said network communication interface is selected from the group consisting of a proprietary Application Programming Interface (API), a Zigbee interface, a WiFi interface, and combinations thereof.

20. (canceled)
